(19) United States
(12) Patent Application Publication
(10) Pub. No.: US 2025/0039179 A1
(43) Pub. Date: Jan. 30, 2025

(54) SINGLE TO MULTIPLE DEVICE RESOURCE NEGOTIATION

(71) Applicant: Telefonaktiebolaget LM Ericsson (publ), Stockholm (SE)

(72) Inventors: Bipin Balakrishnan, Kävlinge (SE); Razvan-Cristian Marin, Lund (SE); Ananya Muddukrishna, Enskededalen (SE); Ashkan Kalantari, Malmö (SE); Shousheng He, Södra Sandby (SE)

(21) Appl. No.: 18/717,850

(22) PCT Filed: Dec. 8, 2021
(86) PCT No.: PCT/EP2021/084845

§ 371 Date: Jun. 7, 2024

(51) Int. Cl. H04L 9/40

(52) U.S. Cl. CPC H04L 63/10; H04L 63/205

(57) ABSTRACT

Systems and methods for single to multiple device resource negotiation are provided. In some embodiments, a method of operating a requesting computing node to orchestrate execution of a peer-to-peer negotiation protocol to gain access, for a requested time period, to resources that are physically located on a remote computing node includes: sending one or more requests, to one or more remote computing nodes, for access to resources that are physically located on the remote computing nodes; receiving, from the remote computing nodes, one or more responses for access to resources that are physically located on the remote computing nodes; and selecting a subset of the responses for access to accept. Some advantages of the embodiments include enabling opportunistic increase in functionality of one physical device (requesting device) by borrowing resources that are locally unavailable, but available for use from another physical device (responding device) within a trusted device group.

### TECHNICAL FIELD

The present disclosure relates generally to resource sharing amongst devices.

### BACKGROUND

By 2025, the number of connected devices is projected to reach 36 billion, representing a 56% increase within 5 years, mainly driven by the usage of Internet-of-Things (IoT), both short-range and wide-area. For additional information, see Ericsson, “Traffic exploration tool: interactive online tool,” 3 Aug. 2020, Available: http://www.ericsson.com/TET/trafficView/loadBasicEditor.ericsson (referred to herein as [1]). This will result in a large increase of the number of personal devices owned by an individual to reflect individual preferences and functionalities. If the personal devices owned by an individual's trusted group (e.g., family, friends) are accounted for, it would be even more, in terms of numbers and unique features. Most of these devices are equipped with Wireless Fidelity (Wi-Fi), Bluetooth (BT) and cellular connectivity. Hence, it is possible to implement a common communication infrastructure. In addition, some of these devices have a large amount of computation, sensing, and memory/storage resources that could be idle for significant periods of time.

Consequently, it would be highly beneficial to be able to share resources of the devices (e.g., general processors, memory/storage, hardware accelerators, sensors (such as camera, Inertial Measurement Unit ((IMU), Light Detection And Ranging (LIDAR)), . . . ) within trusted device groups to enable secure and opportunistic access to the resources that are locally unavailable on the requesting device. Therefore, improved systems and methods for resource sharing are needed.

### SUMMARY

Systems and methods for single to multiple device resource negotiation are provided.

In some embodiments, a method of operating a requesting computing node to orchestrate execution of a peer-to-peer negotiation protocol to gain access, for a requested time period, to resources that are physically located on a remote computing node is disclosed. The requesting computing node sends one or more requests, to one or more remote computing nodes, for access to resources that are physically located on the one or more remote computing nodes. The requesting computing node receives, from the one or more remote computing nodes, one or more responses for access to resources that are physically located on the one or more remote computing nodes. The requesting computing node selects a subset of the one or more responses for access to accept. Some advantages of the embodiments may include: enabling opportunistic increase in functionality of one physical device (requesting device) by borrowing resources that are locally unavailable but available for use from another physical device (responding device) within a trusted device group.

In some embodiments, a device-to-device negotiation protocol, which can be initiated independently of user application for efficient resource sharing within a trusted group of devices is proposed. A device, either in need of additional resources (requesting device) for a known time period or if triggered by a dynamically detected event (e.g., security violation), ranks devices that are willing to share resources (responding devices) in the trusted group based on a variety of factors such as resource performance, reliability, or connection quality. The requesting device signs a contract with the highest-ranked responding device, which is then elevated to “providing device” status, for time-bound access to a specific resource on the providing device. Consequently, the proposed solution enables opportunistic, time-bound performance improvement through secure device collaboration over existing communication frameworks.

### BRIEF DESCRIPTION OF THE DRAWINGS

The accompanying drawing figures incorporated in and forming a part of this specification illustrate several aspects of the disclosure, and together with the description serve to explain the principles of the disclosure.

FIG. 1 illustrates a computing node, according to some embodiments of the present disclosure;

FIG. 2 illustrates a minimum system architecture with one or more vicinities, according to some embodiments of the present disclosure;

FIG. 3 illustrates a method of operating a requesting computing node to orchestrate execution of a peer-to-peer negotiation protocol, according to some embodiments of the present disclosure;

FIG. 4 illustrates a method of operating a remote computing node to orchestrate execution of a peer-to-peer negotiation protocol, according to some embodiments of the present disclosure;

FIG. 5 illustrates a method of group creation, according to some embodiments of the present disclosure;

FIG. 6 illustrates a method of negotiation with responder ranking, according to some embodiments of the present disclosure;

FIG. 7 illustrates a method of negotiation with responder and requester ranking, according to some embodiments of the present disclosure.

### DETAILED DESCRIPTION

The embodiments set forth below represent information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure.

Radio Node: As used herein, a “radio node” is either a radio access node or a wireless communication device.

Radio Access Node: As used herein, a “radio access node” or “radio network node” or “radio access network node” is any node in a Radio Access Network (RAN) of a cellular communications network that operates to wirelessly transmit and/or receive signals. Some examples of a radio access node include, but are not limited to, a base station (e.g., a New Radio (NR) base station (gNB) in a Third Generation Partnership Project (3GPP) Fifth Generation (5G) NR network or an enhanced or evolved Node B (eNB) in a 3GPP Long Term Evolution (LTE) network), a high-power or macro base station, a low-power base station (e.g., a micro base station, a pico base station, a home eNB, or the like), a relay node, a network node that implements part of the functionality of a base station or a network node that implements a gNB Distributed Unit (gNB-DU)) or a network node that implements part of the functionality of some other type of radio access node.

Core Network Node: As used herein, a “core network node” is any type of node in a core network or any node that implements a core network function. Some examples of a core network node include, e.g., a Mobility Management Entity (MME), a Packet Data Network Gateway (P-GW), a Service Capability Exposure Function (SCEF), a Home Subscriber Server (HSS), or the like. Some other examples of a core network node include a node implementing a Access and Mobility Function (AMF), a User Plane Function (UPF), a Session Management Function (SMF), an Authentication Server Function (AUSF), a Network Slice Selection Function (NSSF), a Network Exposure Function (NEF), a Network Function (NF) Repository Function (NRF), a Policy Control Function (PCF), a Unified Data Management (UDM), or the like.

Communication Device: As used herein, a “communication device” is any type of device that has access to an access network. Some examples of a communication device include, but are not limited to: mobile phone, smart phone, sensor device, meter, vehicle, household appliance, medical appliance, media player, camera, or any type of consumer electronic, for instance, but not limited to, a television, radio, lighting arrangement, tablet computer, laptop, or Personal Computer (PC). The communication device may be a portable, hand-held, computer-comprised, or vehicle-mounted mobile device, enabled to communicate voice and/or data via a wireless or wireline connection.

Wireless Communication Device: One type of communication device is a wireless communication device, which may be any type of wireless device that has access to (i.e., is served by) a wireless network (e.g., a cellular network). Some examples of a wireless communication device include, but are not limited to: a User Equipment device (UE) in a 3GPP network, a Machine Type Communication (MTC) device, and an Internet of Things (IoT) device. Such wireless communication devices may be, or may be integrated into, a mobile phone, smart phone, sensor device, meter, vehicle, household appliance, medical appliance, media player, camera, or any type of consumer electronic, for instance, but not limited to, a television, radio, lighting arrangement, tablet computer, laptop, or PC. The wireless communication device may be a portable, hand-held, computer-comprised, or vehicle-mounted mobile device, enabled to communicate voice and/or data via a wireless connection.

Network Node: As used herein, a “network node” is any node that is either part of the RAN or the core network of a cellular communications network/system.

Transmission/Reception Point (TRP): In some embodiments, a TRP may be either a network node, a radio head, a spatial relation, or a Transmission Configuration Indicator (TCI) state. A TRP may be represented by a spatial relation or a TCI state in some embodiments. In some embodiments, a TRP may be using multiple TCI states.

In some embodiments, a TRP may a part of the gNB transmitting and receiving radio signals to/from UE according to physical layer properties and parameters inherent to that element. In some embodiments, in Multiple TRP (multi-TRP) operation, a serving cell can schedule UE from two TRPs, providing better Physical Downlink Shared Channel (PDSCH) coverage, reliability and/or data rates. There are two different operation modes for multi-TRP: single Downlink Control Information (DCI) and multi-DCI. For both modes, control of uplink and downlink operation is done by both physical layer and Medium Access Control (MAC). In single-DCI mode, UE is scheduled by the same DCI for both TRPs and in multi-DCI mode, UE is scheduled by independent DCIs from each TRP.

Note that the description given herein focuses on a 3GPP cellular communications system and, as such, 3GPP terminology or terminology similar to 3GPP terminology is oftentimes used. However, the concepts disclosed herein are not limited to a 3GPP system.

Note that, in the description herein, reference may be made to the term “cell”; however, particularly with respect to 5G NR concepts, beams may be used instead of cells and, as such, it is important to note that the concepts described herein are equally applicable to both cells and beams.

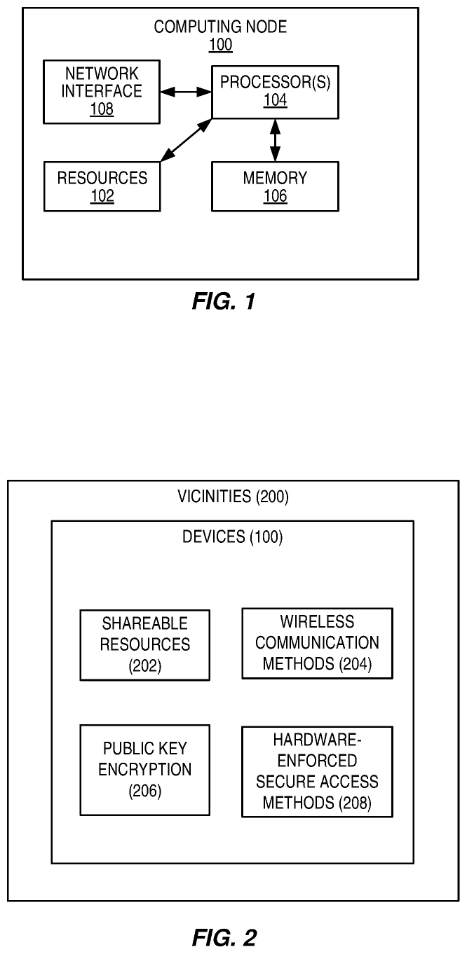

FIG. 1 illustrates a schematic block diagram of a computing node 100 according to some embodiments of the present disclosure. As illustrated, the computing node 100 includes one or more resources 102 which could be shared. The computing node 100 also includes one or more processors 104 (e.g., CPUs, ASICS, FPGAS, and/or the like) and memory 106. In some embodiments, the one or more processors 104 and the memory 106 might be included in the one or more resources 102 which could be shared. The processors 104 are also referred to herein as processing circuitry. In some embodiments, the functionality of the computing node 100 described above may be fully or partially implemented in software that is, e.g., stored in the memory 106 and executed by the processor(s) 104. Note that the computing node 100 may include additional components not illustrated in FIG. 1 such as, e.g., one or more user interface components (e.g., an input/output interface including a display, buttons, a touch screen, a microphone, a speaker(s), and/or the like and/or any other components for allowing input of information into the computing node 100 and/or allowing output of information from the computing node 100), a power supply (e.g., a battery and associated power circuitry), etc.

In some embodiments, a computer program including instructions which, when executed by at least one processor, causes the at least one processor to carry out the functionality of the computing node 100 according to any of the embodiments described herein is provided. In some embodiments, a carrier comprising the aforementioned computer program product is provided. The carrier is one of an electronic signal, an optical signal, a radio signal, or a computer readable storage medium (e.g., a non-transitory computer readable medium such as memory).

A solution for homogenous resource sharing between a local device and a remote device has recently been published (K. C. Wells, “Opportunistic Resource Sharing Between devices” U.S. Pat. No. 10,750,515, 18 Aug. 2020, referred to herein as [2]). The process involves comparing homogeneous resources available on local and remote devices. The availability of these resources is determined using local and remote device resources sharing lists. Next, a resource matching is performed to generate the set of candidate device resources, which can be optionally refined based on additional parameters, such as device name, part number etc., and threshold-based operational parameters (e.g., battery levels). Then a set of homogeneous device resources suitable for sharing between local and remote devices are identified. The local device exchanges negotiation messages with the remote devices to establish one or more conditions for the use of the shared homogeneous device resources. The sharing application assigns “producer” and “consumer” roles to local and remote devices, respectively.

Yet another related solution is the network-assisted device-to-device resource sharing system by Pu et al. (P. L, C. X, X. J and F. X, “D2D Fogging: An Energy-Efficient and Incentive-Aware Task Offloading Framework via Network-assisted D2D Collaboration,” IEEE Journal on Selected Areas in Communications, vol. 34, no. 12, 2016, referred to herein as [3]). Their system allows mobile phone devices to share computation and communication resources mediated by the mobile phone network. The system provides two incentives: a tit-for-tat incentive that allows devices to receive resources as much as they contribute and an energy consumption incentive that enables devices to share resources up to a reserve energy threshold.

One more related work is the elastic resource provisioning operating system by Malaiyandisamy et al. (G. Malaiyandisamy, R. Bhose and S. Mallick, “Elastic Provisioning of Resources via Distributed Virtualization” U.S. Pat. No. 8,978,030, 2011, referred to herein as [4]). Their operating system aggregates computing resources from several physical computing systems and schedules programs on this virtualized resource substrate. The trigger to aggregate more computing resources is an exceeded computation resource utilization threshold.

Another related solution is the modular electronic system with contextual task management (E. H. C. Liu, K. D. Brune, Y. Matsuoka, G. Cabillic and G. Shah, “Modular electronic devices with prediction of future tasks and capabilities”. U.S. Pat. No. 10,282,233, 7 May 2019, referred to herein as [5]). [5] is about initially identifying one or more computing tasks, predicting the resources needed and thereafter checking for availability of resources in local or remote modules and then creating a task schedule that suits availability of the required resources. The electronic module in this system offers a pricing incentive. Requesting modules that declare the request as low-priority are offered a lower price.

The solution in [2] matches the homogeneous (i.e., of same kind) resources between the local and remote devices; concentrates mainly on power management and redundancy; and is limited to homogeneous device resources in proximity and over a network. As such, the solution is beneficial when two or more devices are in proximity and can share homogeneous device resources. For example, if three devices wish to use GPS information from a local GPS component, device-1 will keep its GPS component active and provide the GPS information to the other two devices that have deactivated their local GPS components beforehand to save power. In another example, one of the devices has a faulty component. It can rely on other devices in proximity that are willing to share a similar non-faulty component.

However, the solution in [2] does not address the need of the local device to enhance performance for specific time periods based on the addition of new features provided by heterogenous device resources. For instance, the local device wishes to localize itself (enhancement) but does not have a GPS component and would like to use the GPS component from a remote device. At the same time, the local device might need additional storage or computation power for a specific time period. In this case, the local device could be assisted by a homogeneous resource sharing solution (adding to the local device resources and not replacing homogeneous resources on the local device), thus addressing the need for increased added value, and not for redundancy as in [2], i.e., added storage leading to higher capacity, added compute ability leading to better performance, etc.

Other solutions, such as [5], allow for a loosely coupled ad-hoc system based on an electronic module predicting future availability of module combinations and associated computing resources and/or capable of predicting future tasks. The trustworthiness aspects are not considered in this solution in identifying the devices/modules, which can be an important concern before initiating resource sharing between devices, in some embodiments. In addition, there are no incentives offered for participating in resource negotiation.

In short, existing solutions, such as [2], do not address the need to enhance the capability of a device, by acquiring additional resources from an independent physical device or may omit security aspects, like in [5], creating a loosely coupled system which is not suited for soft real-time applications and is always tuned to the tasks that trigger the request. Furthermore, the solution in [2] does not incentivize the device that is willing to share its resources or indicate how to do an optimal selection from among multiple devices that are willing to share their resources.

The device-to-device resource sharing system by Pu et al. [3] does not incentivize participation in resource negotiation. There is no trial testing of devices (e.g., probation period) prior to the negotiation exposing the requesting device's actual requests. The related works [2], [3], [4], [5] consider resource requirements of application tasks as a trigger for resource negotiation and sharing. This makes their negotiation protocols task-triggered and unable to handle resource sharing situations in the absence of tasks; for example, situations when resource sharing increases energy efficiency and security.

Systems and methods for single to multiple device resource negotiation are provided.

In some embodiments, a method of operating a requesting computing node to orchestrate execution of a peer-to-peer negotiation protocol to gain access, for a requested time period, to resources that are physically located on a remote computing node. The requesting computing node sends one or more requests, to one or more remote computing nodes, for access to resources that are physically located on the one or more remote computing nodes. The requesting computing node receives, from the one or more remote computing nodes, one or more responses for access to resources that are physically located on the one or more remote computing nodes. The requesting computing node selects a subset of the one or more responses for access to accept. Some advantages of the embodiments may include: enabling opportunistic increase in functionality of one physical device (requesting device) by borrowing resources that are locally unavailable but available for use from another physical device (responding device) within a trusted device group.

Some embodiments of the present disclosure relate to a peer-to-peer negotiation protocol that runs in the background without direct communication with any currently executing applications, i.e., a silent negotiation protocol. In some embodiments, this protocol runs in the kernel space and/or is initiated by the kernel. In one embodiment, it is independent of any application tasks and is triggered by system-wide (e.g., local operating system wide and/or device-wide) requirements (e.g., security violation or a need for energy efficiency) to acquire hardware capabilities different in scope compared to those available natively. The protocol enables a device, from now on called the requesting device, to gain access, for a requested time period, to whole or partial resources that are physically located on another device (with permission from the remote device's security management systems), from now on called the responding device. Both requesting and responding devices are part of a trusted group of devices, which has been set up prior to negotiation. In some embodiments, the protocol can negotiate in parallel for different resources on a given responding device as well as simultaneously with multiple responding devices, as highlighted in the examples below. Furthermore, some embodiments incorporate an incentive scheme to reward responding devices. Some embodiments also determine which is the best responding device, in case more are present, using multi-factor ranking criteria. In some embodiments, the device-wide requirement includes imminent security violations, e.g., negotiating for shared resources is a pre-emptive security measure.

FIG. 2 illustrates a minimum system architecture with one or more vicinities (200), according to some embodiments of the present disclosure. In some embodiments, one or more vicinities (200) are provided. In each vicinity (200), two or more devices (100) can interact. In each device (100), one or more shareable resources (202) are included. Additionally, one or more wireless communication methods (204), public key encryption (206), and/or hardware-enforced secure access methods (208) are included.

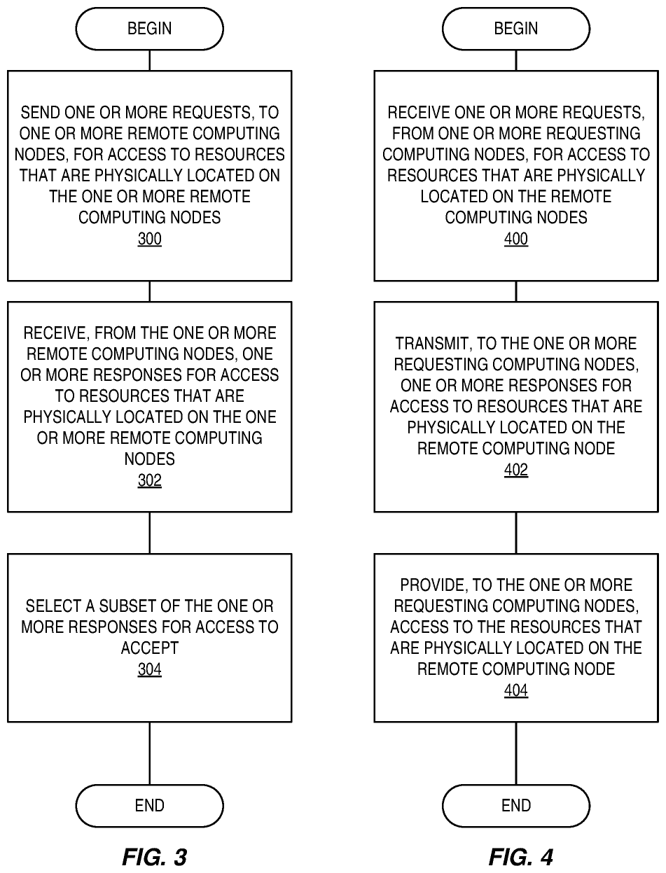

FIG. 3 illustrates a method of operating a requesting computing node to orchestrate execution of a peer-to-peer negotiation protocol, according to some embodiments of the present disclosure. In some embodiments, the requesting computing node sends one or more requests, to one or more remote computing nodes, for access to resources that are physically located on the one or more remote computing nodes (step 300). The requesting computing node receives, from the one or more remote computing nodes, one or more responses for access to resources that are physically located on the one or more remote computing nodes (step 302). The requesting computing node selects a subset of the one or more responses for access to accept (step 304).

FIG. 4 illustrates a method of operating a remote computing node to orchestrate execution of a peer-to-peer negotiation protocol, according to some embodiments of the present disclosure. In some embodiments, the remote computing node receives one or more requests, from one or more requesting computing nodes, for access to resources that are physically located on the remote computing nodes (step 400). The remote computing node transmits, to the one or more requesting computing nodes, one or more responses for access to whole or partial resources that are physically located on the remote computing node (step 402). The remote computing node provides, to the one or more requesting computing nodes, access to the whole or partial resources that are physically located on the remote computing node (step 404).

Negotiation examples include one or more of the following. Negotiating for multiple resources on the same responding device; for example, negotiating for camera access and IMU access in the responding device. Negotiating with multiple responding devices for a given resource in an additive or time-scheduled manner; for example, if 1 GB storage expansion is required, then negotiating for 300 MB storage in device-1, 500 MB storage on device-2, and 200 MB storage in device-3. Another example, if a camera is needed for 1 minute, then negotiating with device-1 for camera access for 20 seconds in interval 1-20 s, negotiating with device-2 for camera access for 40 seconds in interval 20-60 s. Negotiating for executing part of an Artificial Intelligence (AI)/Machine Learning (ML) model on a hardware accelerator in a responding device; for example, a device equipped with a neuromorphic hardware accelerator can handle spiking neural networks efficiently, hence, it can lend it to requesting devices through a negotiation. Some advantages of the embodiments may include: enabling an opportunistic increase in functionality of one physical device (requesting device) by borrowing resources that are locally unavailable but available for use from another physical device (responding device) within a trusted device group.

Resource negotiation and resource sharing runs independently of any application. In some embodiments, application tasks are not the primary triggers for negotiation.

Some embodiments make it possible to share resources efficiently among devices within a trusted group by implementing an efficiency-oriented ranking system, which takes into consideration factors such as link quality, resource performance, and device reliability. In some embodiments, a resource sharing contract is signed between the requesting device and the top ranked responding device.

In some embodiments, the protocol runs on top of existing shared communication infrastructure and leverages security mechanisms such as public-private key encryption and trusted execution environments to securely exchange negotiation messages. Some embodiments maintain security by granting access to resources that are on devices within the trusted group. Optionally, trust between devices can be enhanced through non-uniform member probation times.

Some embodiments of the present disclosure address the dynamic and time-bound need of acquiring a resource from another physical device and envision the presently disclosed technology as a lightweight negotiation protocol that can be implemented over existing communication frameworks such as Wireless Fidelity (Wi-Fi), Bluetooth (BT), and cellular connectivity. The proposed negotiation protocol is based on a set of enabling conditions, which are described next.

First, to maintain trust while sharing resources in some embodiments, the negotiation protocol is executed on a device that is a member of a trusted group of devices. The negotiation protocol can request resources only on those devices that are part of the same trusted group. It is assumed that creating, maintaining and disbanding of this trusted group can be done by leveraging existing state of the art methods (e.g., utilizing applications that leverage Trusted Execution Environments such as ARM TrustZone [6]) and transmitting via secure communication links.

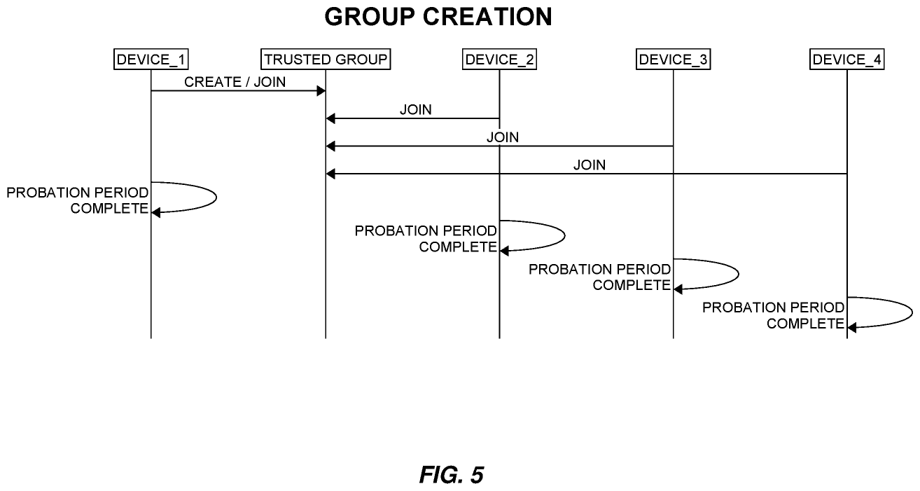

FIG. 5 illustrates a method of group creation, according to some embodiments of the present disclosure. This figure shows an example group formation with devices 1-4 and eventual probation. All devices pass the probation time successfully. As shown in FIG. 5, Device 1 either creates or joins the trusted group. Then Devices 2-4 also join the trusted group. In this example, each device also completes a probation period. One possible group dynamic is that a device starts a new trusted group and becomes the owner of that group. Then, it can invite other known devices in the vicinity to become members of the trusted group. Also, the owner can expel a member from the trusted group, e.g., if the member is inactive or violates rules. At the same time, in some embodiments, the members can leave the trusted group at will. In some embodiments, the trusted device needs to finish the ongoing resource sharing tasks (or contracts) before leaving the trusted group or the trusted device might be penalized if it terminates the contract without completing it. Optionally, trust between devices can be enhanced based on member probation time, i.e., the time for which a given member remains in the trusted group but does not win resource sharing contracts. For example, a requesting device should have stayed in the trusted group for at least “X” time units (e.g., time unit=one day) before qualifying to issue resource requests. The “X” time units value can depend on the requested resource. In some embodiments, a requesting device has to be first a responding device (e.g., that successfully completed any probation requirements) before qualifying to issue resource requests. Likewise, a responding device should have at least “Y” (Y≤X) time units of membership in the trusted group before gaining the ability to negotiate with a requesting device. The “Y” time units value can depend on the resource to be shared. During the probation period, responding devices can additionally be given test tasks to perform to verify the legitimacy of their claimed resource availability. In one embodiment, the responding device may be allowed to respond to resource sharing requests during the probation period but is prevented from winning the sharing contract. In other words, it acts as a dummy responder. In some embodiments, this test task role is to check whether the probation is over or not, to decide if the device can finish the probation. In some embodiments, completion of test tasks can lead to early probation where a device may exit probation before the normal time required given specific conditions, for instance, if a device in probation fulfills a number of X successful dummy actions, namely being rewarded for the successful dummy actions by reducing the amount of probation with respect to normal time. In some embodiments, a benefit of such process is that a separate or centralized “negotiation and sharing” system updates its understanding of the shareable resources and their duration. Such a system could use this information for planning (e.g., fair resource distribution among the members of the trusted group).

Secondly, once a trusted group of devices is established, it is possible via state-of-the-art methods for one device to provide a detailed list of available resources and their capabilities to other devices in the trusted group. For example, if the list contains a non-volatile memory resource, then its capabilities such as capacity, type (NAND/NOR), read speed, etc., are indicated.

Thirdly, it is expected that a responding device should provide access to the requested resource for the negotiated time period. Otherwise, it can be disqualified from further negotiations with the specific requesting device or with all devices in the trusted group. This disqualification can be either temporary (for example, revoked if the contract violation was found to be unavoidable), or permanent. In an extreme case, a device that is disqualified multiple times can be expelled from the trusted group. In some embodiments, if a responding device leaves abruptly, the responding device could be given a higher probation period next time or even be excluded from joining the trusted group if the responding device does not satisfy the current contract.

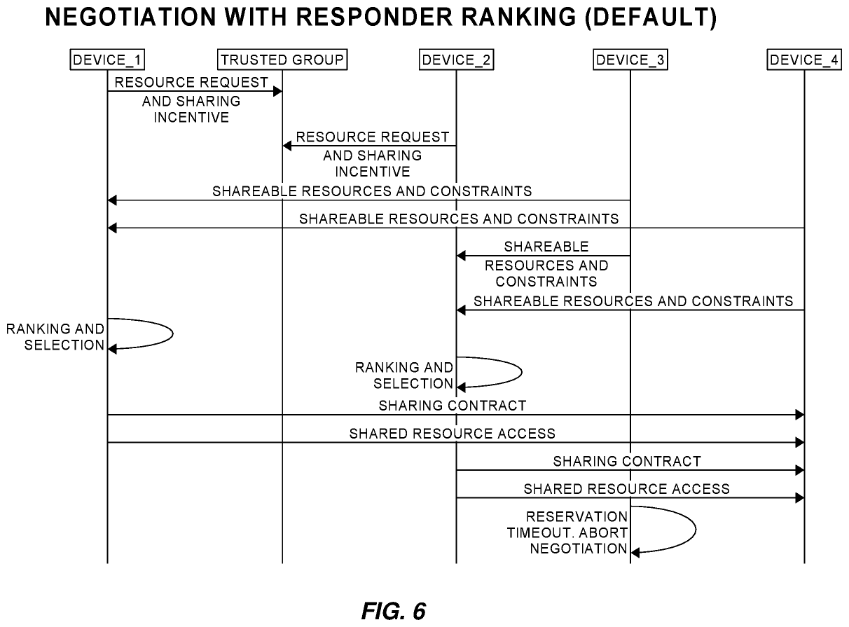

When these enabling conditions hold for a trusted group of devices (i.e., members have a common understanding of group resources and are willing to share resources in a contract-and time-bound manner), then the proposed negotiation protocol works based on the following high-level steps which are illustrated in FIG. 6. FIG. 6 illustrates a method of negotiation with responder ranking, according to some embodiments of the present disclosure. In this example, Devices 1 and 2 send out requests for shared resources. They get responses from Devices 3 and 4. Devices 1 and 2 select Device 4 as the providing device. Device 3 aborts the negotiation after some time.

Step 1. When the requirement for non-local resources arises (e.g., redundancy, capacity increase, low energy, high security, etc.), the protocol entity located on the requesting device, which is defined as the device with a need for a specific resource, broadcasts a resource sharing negotiation request to all the other devices within the trusted device group. Note that the trusted group can be constructed from a common, generic level of security aspects, with the resource/task specific aspects handled in step 2. In some embodiments, the need for non-local resources need not be triggered from application tasks. Such need can instead be triggered by system-wide protocols such as security and battery-saving protocols. For example, if the security protocol infers that local execution is compromised, say due to a malicious virus, then it can trigger the negotiation protocol entity to request secure non-local execution resources. In a similar way, if the battery-saving protocol detects that there are nearby wall-socket powered devices, then it can trigger the negotiation protocol entity. The related work [2] (see column 10 lines 26-40) does not include battery-saving protocols as negotiation trigger.

Step 2. The protocol entity on each responding device (that is willing to share its resources) determines a set of sharing constraints. These constraints could be the portion of the requested resource that is available for sharing, bounds on energy that the shared resource can consume, maximum distance to requesting device. etc. These constraints are then communicated to the requesting device. The responding device reserves the required resource for a predefined reservation time (maximum time period needed by the requesting device to successfully complete resource negotiation and enter a contract with a providing device). If no acknowledgment message is received from the requesting device during this period, then the negotiation is aborted, and the responding device cancels the reservation of the requested resource and makes it available for future negotiation and/or for its own use. This step may involve checking the task/resource specific security requirements before responding.

Step 3. The protocol entity on the requesting device receives from the responding devices the required information necessary for selection. This information can be a list of resources the responding devices is willing to share, resource usage constraints, resource usage trends etc. The selection of the responding device is by default based on the “first come, first served” principle, namely the responding device that answers favorably first gets the resource providing contract. As a separate embodiment, to select the resource providing device, the requesting device ranks the responding devices by analyzing information obtained from the responding devices. Optionally, a response time limit for responding devices can also be set. Ranking methods and efficient negotiation strategies are detailed in the next section.

Step 4. Based on the selection made in step 3 (“first come first served” or top device in the responding device ranking), the requesting device enters a contract for the requested resource and duration with the selected responding device, which is further called the providing device. The protocol entity on the requesting device is required to send a “successful negotiation” message to the providing device within a predefined negotiation time period (maximum time period for the requesting device to successfully complete resource negotiation and enter a contract with a responding device), otherwise the negotiation is aborted by responding devices. Moreover, protocol efficiency is improved, since no unnecessary communication occurs between the requesting devices and the non-selected responding devices.

Step 5. As an enhancement step, the negotiating protocol scores responding devices using methods described below.

The requesting device might consider a combination of the following factors to rank responding devices. The ranking method places responding devices that agree to share efficient resources on top. This ensures that inefficient responding devices are selected only if there are no better alternatives. For example, if the required resource is memory, then the ranking can be made based on energy-efficient properties such as the type of memory (NAND/NOR), memory capacity, read/write speed, e.g., DDR4 memory is more energy efficient that DDR3.

The requesting device might also consider the communication link quality, e.g., Signal to Noise Ratio (SNR), delay, bandwidth, between the requesting and responding devices. In some embodiments, the link quality needs to satisfy the application requirement, e.g., Extended Reality (XR) applications require high date rate or Ultra-Reliable Low-Latency Communication (URLLC) applications requires low delay.

If the requesting device requires a resource that is available on a responding device that is already a providing device for some other resource, the ranking priority of that responding device increases. Hence, the requesting and responding devices can enter several contracts at the same time to share different resources.

The requesting device might also consider the reliability of the responding device, which can be defined as the number of successful resource sharing contracts over the number of responses. The resource parameters of the responding device could be: resource usage trends, available battery energy, time to access the shared resource, etc. For example, a responding device with lower battery energy level makes a resource sharing contract breach likely. Thus, the requesting device will use the specifications of the responding device such as its remaining battery energy level to estimate if the responding device can share resources without adverse battery energy depletion.

Optionally, the responding device estimates how much energy will be consumed by the shared resource for the duration of the request and provides this information to the requesting device. Furthermore, depending on the scenario, if faster access to the shared resource or a shorter transmission time are required, then the requesting device can prefer a responding device with high data transfer rates. The estimation of the amount of energy required during the duration of the request is based on the properties of application tasks that will use the shared resources. In this case, the negotiation protocol is triggered by the requirements of application tasks.

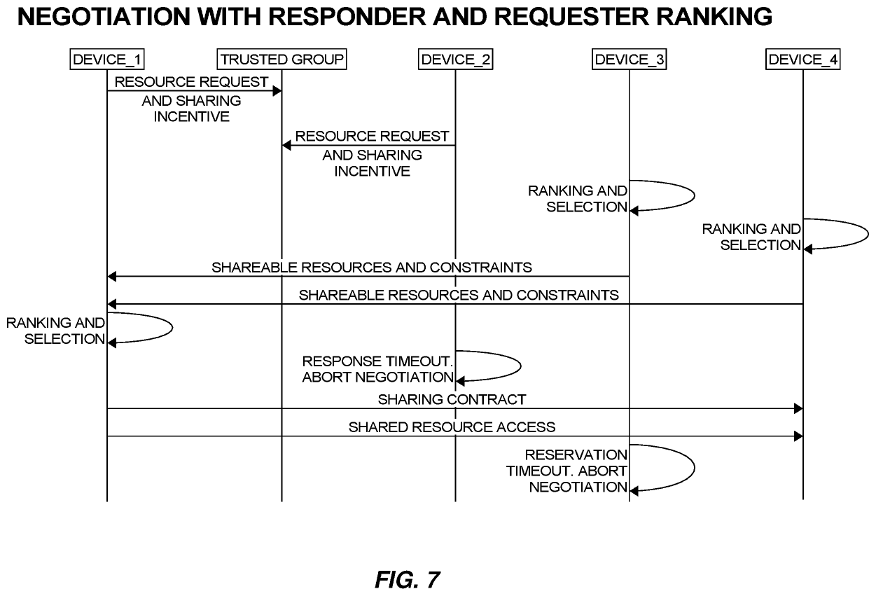

FIG. 7 illustrates a method of negotiation with responder and requester ranking, according to some embodiments of the present disclosure. In this example, Devices 1 and 2 send out requests for shared resources. Devices 3 and 4 rank the requests. Device 1 gets responses from Devices 3 and 4. Device 2 does not get any response and aborts the request. Device 1 selects Device 4 as the providing device.

Similar to the responding device ranking performed by the requesting device, the responding device may also rank requesting devices. For a predefined time period, the responding device listens to incoming resource sharing requests, and then ranks the corresponding requesting devices. Next, the responding device only responds to the top ranked requesting device. It should be noted that the predefined time on the responding device is much less than the requesting device's waiting time. In some embodiments, this is to avoid deadlock and time-out situations.

A responding device may consider a combination of the following factors to rank requesting devices: the requested sharing time interval and the resource availability; the requesting device's estimated resource utilization; the communication link quality to the requesting device; the incentive offered by the requesting device.

The requesting device might also consider the distance between the requesting and the responding devices. A shorter distance reduces the energy required for communication and typically improves link quality. Scores of the responding devices could be used to rank them. See below for how a scoring system could be implemented.

A requesting device can re-order or use a weighted version of the above ranking criteria to select a responding device.

In some embodiments, the resource negotiation may benefit from a scoring mechanism that could keep track of the responding devices and assign a score based on, for example, how fast was the response, sharing time, shared resource performance, success rate, etc. Thus, it is possible to reward not only the “winning” responding device (known as the providing device), but also the responding devices that respond to the request. The values of the scores are not fixed and can vary based on the requesting device's urgency or desired reliability on the level of execution. For example, if the resource requirement is urgent, then it may offer a higher score. The responding devices can advertise the score that the device has accumulated so far, in its response so that the requesting device may use this to select the winning device.

There are a few implementation options with respect to the time for which these earned score points are retained. In some embodiments, the score could be reset on entry: A device keeps its score until it is a member of the trusted group. When a device enters the group, its score is reset to zero and when it exits, its score is discarded by the rest of the trusted group.

In some embodiments, the score could be self-reset: A device in the trusted group may choose to reset its score (for e.g., if the device undergoes a reset).

In some embodiments, the score could be reset externally: The score of a device in the trusted group may be reset by another device or more than one other device in certain scenarios (e.g., device violated a security aspect).

In some embodiments, the score could be suspended: the score could be temporarily paused when the device hibernates or leaves the trusted group for a while and then returns. In this case, the group membership is seen as suspended and not as exited.

An alternative embodiment for the scoring system is that at least two requesting devices compete, e.g., bidding, to get a specific resource from a responding device or the responding devices compete, e.g., by increasing their scores, to offer resources to at least one requesting device. This is applicable in scenarios when there are not tight timing bounds for resource negotiation and securing the arrangement.

In some embodiments, the ranking criteria outlined previously can be augmented or replaced with other approaches. For example, in an alternative embodiment, the implementation of a reinforcement learning algorithm that can learn the optimal order and weights of the ranking criteria would enable automation of the ranking process for an optimal/seamless experience. An important part of the reinforcement learning algorithm is to define the reward function that provides positive rewards for successful decisions and negative rewards otherwise, thus building useful knowledge for future device ranking and selection. In a possible implementation applied to the ranking process, the (reinforcement learning) reward function provides a first positive reward (Rp1>0) when a ranking led to a successful negotiation, whereas if the negotiation failed, then a first negative reward (Rn1<0) is given. Furthermore, in case of successful negotiation (i.e., resource sharing contract is signed), then a second positive reward is given (e.g., Rp2>(2*Rp1)), whereas if the contract is broken, a second negative reward is given (e.g., Rn2<(2*Rn1)). The reward is therefore cumulative. Since machine learning algorithms require a large amount of training data that can take a long time to acquire, in an alternative embodiment, both requesting and responding devices share with each other their own historical ranking data to be used in the training of the reinforcement learning model. For instance, when a requesting device broadcasts a resource sharing request, it also attaches the historical ranking data. Likewise, when the responding device answers to a resource sharing request, it will also share its historical ranking data with the requesting device.

In some embodiments, member devices of a trusted group need not just wait idly during probation. These member devices can act in a dummy manner to better understand the negotiation process. Thus, the device under probation can have an additional flag which is associated with the messages it exchanges with the other devices in the trust group. For example, to initiate a dummy resource sharing request, the device under probation will broadcast the request with the additional probation flag and will receive answers from responding devices. The process is almost the same, except for the actual resource sharing (entering a resource sharing contract), and that the responding device will not reserve the requested resource during negotiation with a requesting device under probation. At the same time, the device under probation can also listen to incoming resource sharing requests and respond to the requesting device with the additional probation flag. Then, the requesting device will also consider in the ranking process the responding device under probation. Optionally, the requesting device might also send out the result of the ranking (i.e., ranking order) to the responding devices under probation.

Any appropriate steps, methods, features, functions, or benefits disclosed herein may be performed through one or more functional units or modules of one or more virtual apparatuses. Each virtual apparatus may comprise a number of these functional units. These functional units may be implemented via processing circuitry, which may include one or more microprocessors or microcontrollers, as well as other digital hardware, which may include Digital Signal Processors (DSPs), special-purpose digital logic, and the like. The processing circuitry may be configured to execute program code stored in memory, which may include one or several types of memory such as Read Only Memory (ROM), Random Access Memory (RAM), cache memory, flash memory devices, optical storage devices, etc. Program code stored in memory includes program instructions for executing one or more telecommunications and/or data communications protocols as well as instructions for carrying out one or more of the techniques described herein. In some implementations, the processing circuitry may be used to cause the respective functional unit to perform corresponding functions according one or more embodiments of the present disclosure.

While processes in the figures may show a particular order of operations performed by certain embodiments of the present disclosure, it should be understood that such order is exemplary (e.g., alternative embodiments may perform the operations in a different order, combine certain operations, overlap certain operations, etc.).

At least some of the following abbreviations may be used in this disclosure. If there is an inconsistency between abbreviations, preference should be given to how it is used above. If listed multiple times below, the first listing should be preferred over any subsequent listing(s).
3GPP Third Generation Partnership Project
5G Fifth Generation
AF Application Function
AMF Access and Mobility Function
ASIC Application Specific Integrated Circuit
AUSF Authentication Server Function
BT Bluetooth
CPU Central Processing Unit
DCI Downlink Control Information
DDR Dialed Digit Reporting
DSP Digital Signal Processor
eNB Enhanced or Evolved Node B
FPGA Field Programmable Gate Array
gNB New Radio Base Station
gNB-DU New Radio Base Station Distributed Unit
HSS Home Subscriber Server
IMU Inertial Measurement Unit
IoT Internet of Things
LiDAR Light Detection And Ranging
LTE Long Term Evolution
MAC Medium Access Control
MME Mobility Management Entity
MTC Machine Type Communication
NEF Network Exposure Function
NF Network Function
NR New Radio
NRF Network Function Repository Function
NSSF Network Slice Selection Function
PC Personal Computer
PCF Policy Control Function
PDSCH Physical Downlink Shared Channel
P-GW Packet Data Network Gateway
RAM Random Access Memory
RAN Radio Access Network
ROM Read Only Memory
SCEF Service Capability Exposure Function
SMF Session Management Function
SNR Signal to Noise Ratio
TCI Transmission Configuration Indicator
TRP Transmission/Reception Point
UDM Unified Data Management
UE User Equipment
UPF User Plane Function
URLLC Ultra Reliable Low Latency Communication
Wi-Fi Wireless Fidelity
XR Extended Reality

Those skilled in the art will recognize improvements and modifications to the embodiments of the present disclosure. All such improvements and modifications are considered within the scope of the concepts disclosed herein.

1-34. (canceled)

35. A method of operating a requesting computing node to orchestrate execution of a peer-to-peer negotiation protocol to gain access, for a requested time period, to resources that are physically located on a remote computing node, the method comprising:
sending one or more requests, to one or more remote computing nodes, for access to the resources that are physically located on the one or more remote computing nodes;
receiving, from the one or more remote computing nodes, one or more responses for access to the resources that are physically located on the one or more remote computing nodes; and
selecting a subset of the one or more responses for access to accept.

36. The method of claim 35 wherein the one or more requests comprise a requested time period for access to the resources.

37. The method of claim 35 wherein both the requesting computing node and the one or more remote computing nodes are part of a trusted group of devices, which has been set up prior to sending the one or more requests.

38. The method of claim 35 wherein the peer-to-peer negotiation protocol runs in a background of the requesting computing node without direct communication with any currently executing applications on the requesting computing node.

39. The method of claim 38 wherein the peer-to-peer negotiation protocol runs in a kernel space of the requesting computing node and is initiated by a kernel of the requesting computing node.

40. The method of claim 35 wherein sending the one or more requests is in response to a triggering of a device-wide requirement and wherein the device-wide requirement comprises one or more of the group consisting of: a security violation; a need for energy efficiency; and a need for resources unavailable at the requesting computing node.

41. The method of claim 35 wherein selecting the subset of the one or more responses for access to accept comprises implementing an efficiency-oriented ranking system, which takes into consideration one or more factors from the group consisting of: a link quality; a resource performance; and a device reliability.

42. The method of claim 35 wherein selecting the subset of the one or more responses for access to accept further comprises signing a resource sharing contract between the requesting computing node and the one or more remote computing nodes.

43. The method of claim 35 wherein any of the steps leverage, to securely exchange negotiation messages, one or more security mechanisms selected from the group consisting of:
public-private key encryption; and trusted execution environments.

44. A method of operating a remote computing node to orchestrate execution of a peer-to-peer negotiation protocol to grant access, for a requested time period, to resources that are physically located on the remote computing node, the method comprising:
receiving one or more requests, from one or more requesting computing nodes, for access to the resources that are physically located on the remote computing nodes;
transmitting, to the one or more requesting computing nodes, one or more responses for access to the resources that are physically located on the remote computing node; and
providing, to the one or more requesting computing nodes, access to the resources that are physically located on the remote computing node.

45. The method of claim 44 wherein the one or more requests comprise a requested time period for access to the resources.

46. The method of claim 44 wherein both the one or more requesting computing nodes and the remote computing node are part of a trusted group of devices, which has been set up prior to sending the one or more requests.

47. The method of claim 44 wherein the peer-to-peer negotiation protocol runs in a background of the remote computing node without direct communication with any currently executing applications on the remote computing node.

48. The method of claim 47 wherein the peer-to-peer negotiation protocol runs in a kernel space of the remote computing node and is initiated by a kernel of the remote computing node.

49. The method of claim 44 wherein receiving the one or more requests is in response to a triggering of a device-wide requirement in the one or more requesting computing nodes and wherein the device-wide requirement comprises one or more of the group consisting of: a security violation; a need for energy efficiency; and a need to resources unavailable at the requesting computing node.

50. The method of claim 44 wherein transmitting the one or more responses comprises implementing an efficiency-oriented ranking system, which takes into consideration one or more factors from the group consisting of: a requested sharing time interval; resource availability; a requesting device's estimated resource utilization; communication link quality; an incentive offered by the requesting device; a link quality to the requesting device; and a distance between the requesting and the responding devices.

51. The method of claim 44 wherein transmitting the one or more responses further comprises signing a resource sharing contract between the remote computing node and the one or more requesting computing nodes.

52. The method of claim 44 wherein any of the steps leverage, to securely exchange negotiation messages, one or more security mechanisms selected from the group consisting of: public-private key encryption; and trusted execution environments.

53. A requesting computing node that is operable to orchestrate execution of a peer-to-peer negotiation protocol to gain access, for a requested time period, to resources that are physically located on a remote computing node, the requesting computing node comprising one or more processors and memory that is configured to:
send one or more requests, to one or more remote computing nodes, for access to the resources that are physically located on the one or more remote computing nodes;
receive, from the one or more remote computing nodes, one or more responses for access to the resources that are physically located on the one or more remote computing nodes; and
select a subset of the one or more responses for access to accept.

54. A remote computing node that is operable to orchestrate execution of a peer-to-peer negotiation protocol to gain access, for a requested time period, to resources that are physically located on the remote computing node, the remote computing node comprising one or more processors and memory that is configured to:
receive one or more requests, from one or more requesting computing nodes, for access to the resources that are physically located on the remote computing nodes;
transmit, to the one or more requesting computing nodes, one or more responses for access to the resources that are physically located on the remote computing node; and
provide, to the one or more requesting computing nodes, access to the resources that are physically located on the remote computing node.
